(19) United States
(12) Patent Application Publication
(10) Pub. No.: US 2017/0286828 A1
(43) Pub. Date: Oct. 5, 2017

(54) Cognitive Neural Architecture and Associated Neural Network Implementations

(71) Applicant: James Edward Smith, Missoula, MT (US)

(72) Inventor: James Edward Smith, Missoula, MT (US)

(21) Appl. No.: 15/083,683

(22) Filed: Mar. 29, 2016

(51) Int. Cl. G06N 3/08; G06N 3/04

(52) U.S. Cl. CPC G06N 3/08; G06N 3/04

(57) ABSTRACT

A spiking neural network in which communication and computation is performed on data represented as points in actual time. Such neural networks provide new ways of performing computation in human-engineered computing systems that employ the same basic paradigm as the mammalian neocortex. Information is encoded based on the relative timing of individual voltage spikes produced, consumed, and computed upon by groups of neurons. Component and interconnection delays are an integral part of the computation process. Multi-connection paths between pairs of neurons are modeled as a single compound path. Multi-layer networks are trained from the input layer proceeding one layer at a time to the output layer. Training involves a computation that is local to each synapse, and synaptic weights are determined by an averaging method. The action of inhibitory neurons is modeled as a bulk process, rather than with individual neurons.

### CROSS-REFERENCE TO RELATED APPLICATIONS

This application claims the benefit of U.S. Provisional Application No. 62/141,486, filed Apr. 1, 2015, the disclosure of which is incorporated herein by reference.

### BACKGROUND OF THE INVENTION

The claimed invention relates to a model and implementation of neural networks in which communication and computation is performed on data represented as points in actual time. These correspond to the times that voltage spikes occur in the biological neocortex. Such neural networks have application to machine learning.

The benefits of such neural networks include new ways of performing computation in human-engineered computing systems that employ the same basic paradigm as the mammalian neocortex. These new ways of performing computation will lead to improvements in existing cognitive functions such as pattern classification and identification as well as other, more advanced cognitive functions which current computer technologies have thus far proven incapable of implementing.

Neural networks may be implemented with a combination of computational hardware and software, and are intended to implement a computational paradigm that is analogous to the paradigm used in the biological neocortex. A neural network is constructed of interconnected functional processing elements, which operate in a concurrent, parallel fashion, rather than in an algorithmic step-by-step fashion as in a conventional von Neumann computer.

Most prior art conventional artificial neural networks are based on the assumption that information is encoded based on the rates of the voltage spikes, in contrast to encoding information based on timing relationships of individual spikes as is done in the claimed invention. Prior art based on spike rates includes the neural networks that form the basis for much of machine learning, including deep learning and convolutional neural network.

Prior art artificial neural networks generally require a very time-consuming training process involving gradient-descent and back-propagation. In contrast, the claimed invention is trained very efficiently a quickly via an averaging process.

A listing of related references follows.
Maass, Wolfgang, Networks of spiking neurons: the third generation of neural network models, Neural networks 10.9 (1997): 1659-1671.
Maass, Wolfgang. “Noisy Spiking Neurons with Temporal Coding have more Computational Power than Sigmoidal Neurons.” In Advances in Neural Information Processing Systems 9: Proceedings of the 1996 Conference, vol. 9, p. 211. MIT Press, 1997.
Natschläger, Thomas, and Berthold Ruf. “Spatial and temporal pattern analysis via spiking neurons.” Network: Computation in Neural Systems 9, no. 3 (1998): 319-332
Hopfield, J. J. “Pattern recognition computation using action potential timing for stimulus representation.” NATURE 376 (1995): 33.
Gerstner, Wulfram, Richard Kempter, J. Leo van Hemmen, and Hermann Wagner. “A neuronal learning rule for sub-millisecond temporal coding.” Nature 383, no. 6595 (1996): 76-78.
Bohte, Sander M., Han La Poutré, and Joost N. Kok. “Unsupervised clustering with spiking neurons by sparse temporal coding and multilayer RBF networks,” IEEE Transactions on Neural Networks, 13, no. 2 (2002): 426-435.
Bohte, Sander M., Joost N. Kok, and Han La Poutre. “Error-backpropagation in temporally encoded networks of spiking neurons.” Neurocomputing 48, no. 1 (2002): 17-37.
Thorpe, Simon J. “Why connectionist models need spikes.” Computational Modelling in Behavioural Neuroscience: 21.
Gerstner, W., and W. M. Kistler, Spiking Neuron Models: Single Neurons, Populations, Plasticity, Cambridge University Press, 2002.
Morrison, Abigail, Markus Diesmann, and Wulfram Gerstner. “Phenomenological models of synaptic plasticity based on spike timing.” Biological cybernetics 98, no. 6 (2008): 459-478.
Paugam-Moisy, Helene, and S. M. Bohte, “Computing with Spiking Neuron Networks”, Handbook of Natural Computing, 40p. Springer, Heidelberg (2009).
LeCun, Yann, Léon Bottou, Yoshua Bengio, and Patrick Haffner. “Gradient-based learning applied to document recognition.” Proceedings of the IEEE 86, no. 11 (1998): 2278-2324.
Smith, James E. “Efficient digital neurons for large scale cortical architectures.” In Proceeding of the 41st annual international symposium on Computer architecture, pp. 229-240. IEEE Press, 2014.
Guyonneau, Rudy, Rufin Vanrullen, and Simon J. Thorpe. “Neurons tune to the earliest spikes through STDP.” Neural Computation 17, no. 4 (2005): 859-879.
Guyonneau, Rudy, Rufin VanRullen, and Simon J. Thorpe. “Temporal codes and sparse representations: A key to understanding rapid processing in the visual system.” Journal of Physiology—Paris 98 (2004): 487-497.
Lippmann, Richard, “An Introduction to Computing with Neural Nets”, ASSP Magazine, IEEE 4.2 (1987): 4-22.

### SUMMARY OF THE INVENTION

In the claimed invention, it is assumed that information is encoded based on the relative timing of individual voltage spikes produced, consumed, and computed upon by groups of model neurons. Such a group of neurons acting in concert is referred to as a column.

Information is encoded as spike timing using a model of actual time, measured as small, discrete time divisions. The use of actual time departs significantly from the way that traditional neural networks operate, and it departs significantly from virtually every human-engineered method of performing computation. These conventional human-engineered computing methods use simple time abstractions (clock cycles and algorithmic steps, for example) in such a way that the results are independent of timing delays of the physical components and interconnections that actually implement the computational method.

In the spiking neural networks that are the subject of the claimed invention, component and interconnection delays are an integral part of the computation process. The results of a computation, in whole or in part, are determined by the time and delays required to perform a computation; this is the complete opposite of conventional computing methods, both in conventional artificial neural networks and other types of computing methods, wherein the results are independent of timing delays in performing the computation.

Conventional artificial neural networks, which contain multiple layers of model neurons, and which form the basis for most machine learning methods, are typically trained by a very time-consuming method involving gradient descent and back propagation (from output(s) to inputs). The same training set is applied many times, with the weights gradually converging to their final values.

The multi-layer spiking neural networks that are the subject of the claimed invention are trained from the input layer proceeding one layer at a time to the output layer. Training involves a computation that is local to each synapse. Synaptic weights are determined by a method which computes average input spike times and converts the average to synapse weights. This method does not require the repeated application of the same training patterns, and consequently is much faster and computationally far more efficient than methods used in traditional artificial neural networks.

In biological neurons, there may be multiple synaptic paths connecting the same two neurons. Hence, in the claimed invention there are multiple paths connecting the two neurons and the paths connecting the first to the second may have different delays and synaptic weights. Herein, the multiple paths connecting the two neurons are referred to as a compound connection. Because the time of the post-synaptic neuron's output spike depends on the relative delays of the input spikes that affect its body potential, the weights of synapses in a compound connection greatly affect the post-synaptic neuron's output spike time, and therefore the output information that is conveyed to other neurons in the network.

In the claimed invention, the action of inhibitory neurons is modeled as a bulk process, rather than with individual neurons. Depending on the pattern of spikes emitted by a group of neurons, referred to as a column, inhibition may eliminate some or all of a column's emitted spikes before they reach other neurons. One form of inhibition eliminates spikes that occur some fixed time later than the first spike emitted by a column. Another form of inhibition eliminates all the spikes emitted by a column if more than a certain number of spikes occur within a specified time with respect to the first spike emitted by the column.

The claimed invention thus includes the features of: communication and computation based on relative times of individual modeled spikes, the modeling of multi-connection paths as a single compound path, synapse weight training via an averaging process, and bulk inhibition that operates on spikes emitted from groups of neurons acting in concert (i.e., columns).

### BRIEF DESCRIPTION OF THE DRAWINGS

FIG. 1 shows sequences of neuron spikes encoding a rate.

FIG. 2 shows individual neuron spikes encoding spike timing relationships.

FIG. 3 shows interconnected computational columns.

FIG. 4 shows the basic building blocks and construction of a computational column.

FIG. 5 shows an example volley and the relationship between values and spike times.

FIG. 6 shows the way that actual time is maintained in a network implementation.

FIG. 7 is a block diagram of the spiking neuron model.

FIG. 8 shows the response to a spike.

FIG. 9 shows two example spike response functions.

FIG. 10 shows a compound connection between two neurons.

FIG. 11 shows conventional synaptic update rules.

FIG. 12 shows a preferred embodiment of synaptic update rules.

FIG. 13 is an example of weights on compound connections after STDP training.

FIG. 14 is the block diagram illustrating the computation performed by the spiking neuron model.

FIG. 15 shows two forms of inhibition; lateral inhibition on left and feedforward inhibition on right.

FIG. 16 shows the weighs of an RBF neuron following training.

FIG. 17 shows a comparison of a conventional synaptic update rule and the RBF neuron update rule.

FIG. 18 shows EPSP waveforms for a selected set of compound synaptic weights.

FIG. 19 shows piecewise linear approximation to compound EPSP behavior.

FIG. 20 shows parameterized piecewise linear weight functions.

FIG. 21 shows example response functions for weights 2, 4, 6, 8.

FIG. 22 shows example shifted weight functions for T=<0,12,4,8>.

FIG. 23 shows shifted response functions when all reach maximum values a the same time.

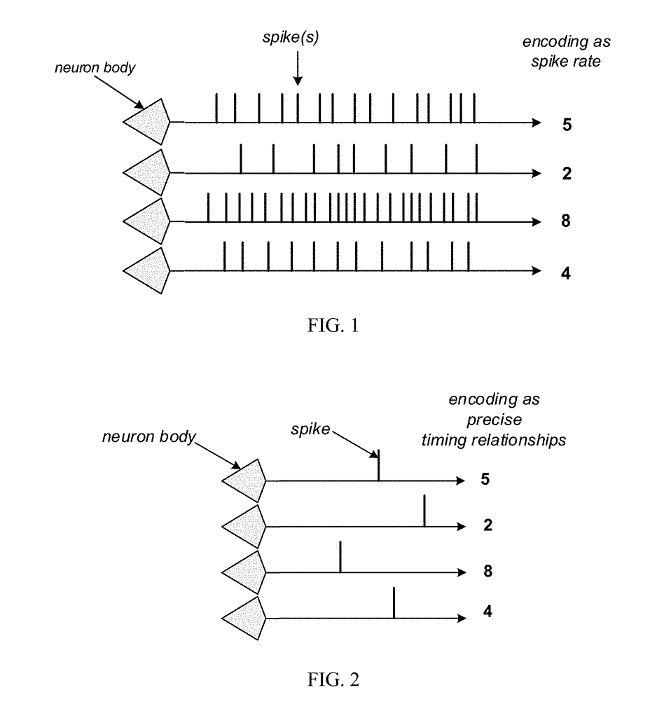

FIG. 1. shows example shifted response functions where S(X,W).

FIG. 25 shows spiking neural network constructed of levelized, feedforward computational columns.

FIG. 26 shows a hierarchical classification system with regular interconnection patterns at each level.

FIG. 27 is an example architecture implemented with the software development system.

FIG. 28 Shows interconnected implementation blocks.

### DETAILED DESCRIPTION OF THE INVENTION

This document describes a type of spiking neural network and supporting implementations based on models which employ neuron-like operation.

A spiking neural network contains model neurons that implement communication and computation based on timing relationships among multiple, concurrently occurring voltage spikes. The way time is modeled in the claimed invention, i.e. the time abstraction, provides each model neuron with its own temporal frame of reference for actual time. A voltage spike is modeled by specifying the actual time a spike occurs and the line on which the spike occurs. Actual time is measured in discrete time intervals, and the claimed spiking neural computing model maintains actual time as a critical part of a useful spiking neural network abstraction.

As is commonly accepted, if voltage spikes communicate information from one neuron to another, there are two main ways communication can be done. Many variations and hybrids have been proposed, but for simplicity here, they are distilled down to two.

FIG. 1 illustrates spike sequences with actual time going from left to right. In the figure, the leftmost spike is the first to occur in time. This is a widely used encoding method where spikes being transmitted from one neuron to another are converted to a single numerical rate. Although there may be jitter amongst the spikes on a given line, it is the overall spike count in a given time interval that is important. This abstraction is often cited for prior art perceptron-type neuron models, and forms the basis for most of the artificial neural network and machine learning research and development that has taken place over the past few decades.

In contrast, FIG. 2 illustrates the method of the claimed invention wherein spike timing relationships across multiple lines convey information. In the figure, time flows from left to right. The first spike in time establishes a temporal frame of reference, and the other spikes convey information based on their relative time offset from that first spike. This method encodes values according to spike times relative to the time of the first spike in a group. In FIG. 2, the values range from 0 to 8. Given that time goes from left to right, the leftmost spike is first. Because it is first, it is assigned the maximum value of 8. Then all the other spikes encode values that are relative to the 8. For example, the latest occurring spike (2^{nd} line from the top) is assigned the much lower value of 2. The bottom spike is ⅓ of the relative time separating the 2 and the 8 and therefore encodes a value of 4, and the top spike which occurs slightly earlier encodes a value of 5. This second method is used in this invention; it is described in more detail later.

The challenge of using spike timing relationships for communicating and processing information is coming up with a suitable abstraction which is simple to use, while retaining the information-carrying time relationships within local frames of reference. The claimed invention uses one such information representation.

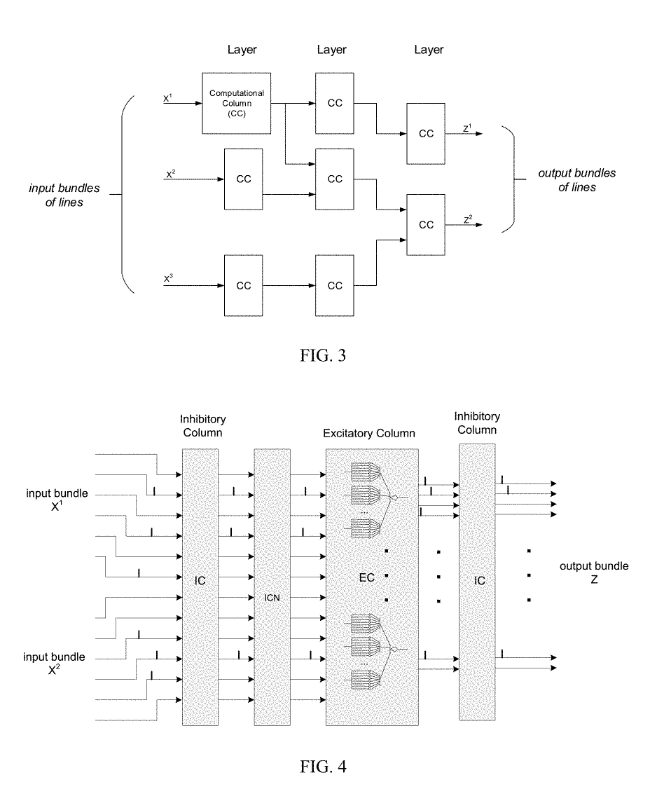

A simple block diagram of an overall spiking neural network architecture is illustrated in FIG. 3. The primary functional unit is a Computational Column, CC. The simpler term “column” will sometimes be used to refer to a CC. Multiple, parallel CCs are combined to form a layer. As shown in FIG. 3, input data is applied to the system, passed among columns, and output via lines that are combined into bundles. The information conveyed on a bundle of lines typically encodes some type of pattern which depends on the application. For example, the pattern may be a raw image expressed as pixels or it may be a pre-processed image; for example, pre-processing may perform edge-detection. Other example patterns include encoded audio phonemes and groups of related physical quantities as might be gathered by an array of temperature and/or pressure sensors.

Shown in FIG. 3 all of the bundle interconnections are in a feedforward direction, although, in general, CCs may contain feedback interconnections.

The CCs transform the input patterns conveyed on the input bundles into intermediate spike patterns which are passed to subsequent columns and eventually an encoded output spike patterns on output bundles are produced. The type of transformation performed by the CCs also depends on the application. Commonly, the transformation is based on pattern similarity. That is, if two different input patterns are similar, the output patterns are also similar; conversely, if two different input patterns are dissimilar, the output patterns are dissimilar. It is typically the case that the sizes of the input bundles and the numbers of different encoded input patterns are significantly larger than the sizes of the output bundles and output pattern encodings. That is, the system performs information reduction or compression based on pattern similarity.

In one application, the spiking neural network composed of CCs may perform classification, where the input patterns are placed into one of a number of disjoint classes based on similarity. For example, if the input patterns are formed from hand written numerals 0-9 in grayscale pixel form, then the output bundle may consist of ten lines, one for each numeral, with the output pattern consisting of a 1-out-of-10 encoding of the handwritten input numeral. In another application, the network may divide the input patterns into “natural” clusters; where each cluster contains patterns that are similar to one another. The identification of clusters and recognition of classes are but two examples of a tasks that may be implemented with the claimed invention.

The term “spike” refers to the voltage spikes (or action potentials) by which biological neurons are thought to communicate. A spike denotes either a relative point in time (the first spike in a volley appears at time 0), or a value associated with the spike's time.

The information carried in a bundle of lines is encoded with spike volleys, which are vectors wherein each element (or spike) belonging to a volley is conveyed on one of the lines in the bundle. In FIG. 3, bundles are labeled Xⁱ at the inputs and Zⁱ at the outputs.

Observe that although references to “time” are used throughout this document, time units and references serve only to help intuitive reasoning by making a connection with physical behavior. Using time units and references is technically unnecessary and is not a requirement; what are referred to as “times” can also be dimensionless quantities, just as values are.

In this document, only spiking neural networks with feedforward signal flow are described in detail, recognizing that such a feedforward network could be a subnetwork of a larger system containing higher level feedback among subnetworks. Furthermore, as in the example systems described in this document, the columns are arranged in distinct layers as shown in FIG. 3. There may be multiple CCs operating in parallel in the same layer. Distinct layering is not a requirement; the methods described in this document may also be used in feedforward networks that do not contain distinct layering.

As shown in FIG. 4, a CC is further composed of an Excitatory Column, (EC), and one or more Inhibitory Columns (ICs). They are connected through an interconnection network (ICN). The EC is a collection of individual spiking neurons that perform the computational work of the column. Based on the spike volleys at their inputs, the neurons in an EC generate output spike volleys according to a specified function to be described later. The input volley of an IC is the output volley of a preceding EC, given the feedforward flow of spike volleys. The IC may operate at a more abstract level than the EC's neurons. Based on the level of activity (e.g., number of spikes) at the inputs of an IC, the IC modifies the activity level (typically by deleting or eliminating spikes) and thereby generates its output volley.

In designs envisioned, the typical number of neurons in an EC might be a few tens, but in theory any number of neurons could be used. The neurons comprising the EC operate in parallel as illustrated in FIG. 4.

As stated earlier, information transmitted among CCs is encoded as spike volleys which are conveyed on bundles of lines. A key property of volleys in the systems envisioned here is that similar patterns are represented by similar volleys. However, all the spikes in the volley are not of equal importance when indicating similarity. The first spike in the volley is the most important (as measured by the time the spike occurs relative to the other spikes in the volley). That is, if two patterns are represented with volleys having their first spikes on the same line, then this is the strongest indicator of similarity. Conversely, if the first spikes are on different lines, the patterns being represented are relatively dissimilar. If both the first and second spikes of both patterns are on the same lines, then the degree of similarity is greater than if only the first spikes are on the same line. Similarity is greater still if the second spikes occur at the same relative time with the respect to the first spikes (or are very close to the same relative time). However, the second spikes are not as important as the first spikes for indicating degrees of similarity. This feature of declining importance continues for subsequent spikes, with each subsequent spike being less important than the previous for indicating similarity. At some point, later spikes become nearly irrelevant for indicating similarity.

Briefly, a supporting argument for the property just described is that a spike is first in a volley if the neuron that produces it is the most strongly stimulated of all the neurons contributing to the volley. Hence, the first spike's relative time and the output line on which it occurs indicate that the input volley at its inputs is strongly matched to the corresponding neuron's trained synapses. The premise that the first spike(s) are more important for indicating neuron stimulation strength (and therefore similarity) serves as a guiding principle for the computational paradigm described in this document.

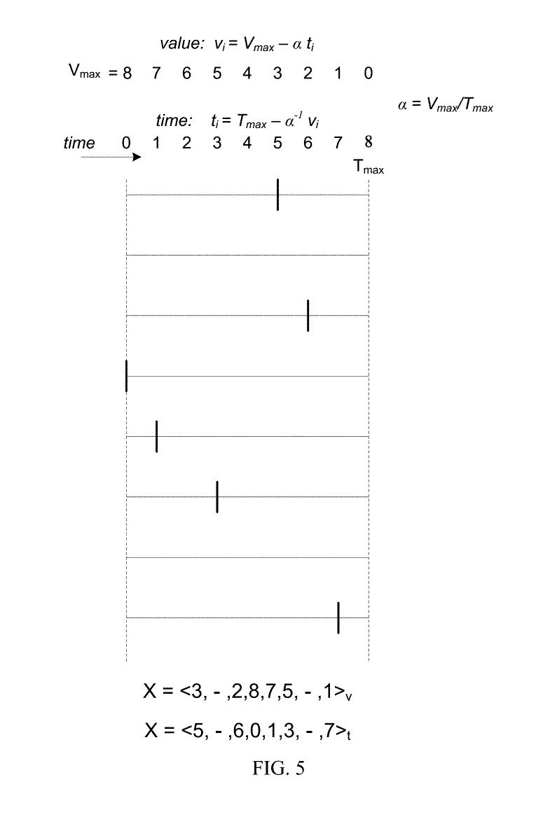

A spike volley may be denoted either as a time volley or as an equivalent value volley. Refer to FIG. 5. A time volley is a vector wherein each spike represents the relative time tᵢ that a spike occurs on line i. A time volley is normalized if at least one of the tᵢ=0. In a normalized volley, Tₘₐₓ is the latest time at which a spike may occur, so 0≦tᵢ≦Tₘₐₓ. Tₘₐₓ defines the maximum extent of a temporal frame of reference; i.e., the time interval over which all spikes in the volley must occur. In this document, volleys may be in either normalized or unnormalized form. However, prior to processing by a CC they are always placed in normalized form in order to establish their values within each neuron's local frame of reference.

Notation: A time volley is denoted with a t subscript following the vector; for example:

X=<x₁, x₂, . . . xₙ>ₜ

In a single volley at most one spike may appear on a given line, and some lines may have no spikes in a given volley. The symbol “-” denotes the absence of a spike on a given line. So for example, A=<5, -, 6,0,1,3, -, 7>ₜ is a normalized time volley as illustrated in FIG. 5.

Given that the earlier spikes are considered to be more important for indicating pattern similarity, it is conceptually useful to adopt a convention where the earlier in time that a spike occurs, the higher the value it encodes. This is done via a defined linear relationship between the spike times and the values they represent. Consequently, the values encoded by a spike volley can alternatively be represented as a value volley A=<a₁, a₂, . . . aₙ>ᵥ, 0≦aᵢ≦Vₘₐₓ.

Notation: A value volley is denoted with a “v” subscript; for example:

X=<x₁, x₂, . . . xₙ>ᵥ; 0≦xᵢ≦Vₘₐₓ

There is a linear relationship between time volleys and value volleys: vᵢ=α (Tₘₐₓ−tᵢ), where α is a proportionality constant; α=Vₘₐₓ/Tₘₐₓ. If there is no spike on line i, the time is given as a dash (i.e., tᵢ=“-”). If and only if tᵢ=“-” then vᵢ=“-”.

For example, the spike volley given in FIG. 5 is represented as both a value volley and its equivalent time volley. The value volley X=<3,-,2,8,7,5,-, 1>ᵥ is equivalent to the time volley given above: X=<5,-,6,0,1,3,-,7>ₜ. In the example shown in FIG. 5, α=1 because Tₘₐₓ=Vₘₐₓ=8. In general, a may be any positive number.

If a time volley is normalized, then the corresponding value volley is also normalized; that is, at least one of the vᵢ=Vₘₐₓ=α Tₘₐₓ. Note that one can easily work interchangeably in either the time domain or in the value domain because the transformation from one to the other is a trivial, linear one to one mapping. That is, vᵢ=α (Tₘₐₓ−tᵢ) and tᵢ=α⁻¹ (Vₘₐₓ−vᵢ).

Notation: A generic volley, which may be either a time volley or a value volley, is denoted with no prefix for example: X=x₁, x₂, . . . xₙ>. Superscripts may be also used to distinguish different volleys; for example: X¹, X², X^{p}.

During regular operation an input volley X=x₁, x₂, . . . xₘ>, 0≦xᵢ≦Xₘₐₓ is presented to the inputs of a column; A column produces an output volley Z=z₁, z₂, . . . zₙ>, 0≦zᵢ≦Zₘₐₓ. In an interconnected system consisting of multiple CCs, an output volley from one column is transmitted along a bundle of lines and will typically provide the input volley (or part of an input volley) to a subsequent column. It is assumed that only one volley per processing step is presented at the inputs of a CC, the CC processes the volley, produces an output for following CC(s), and then is ready to process the next input volley.

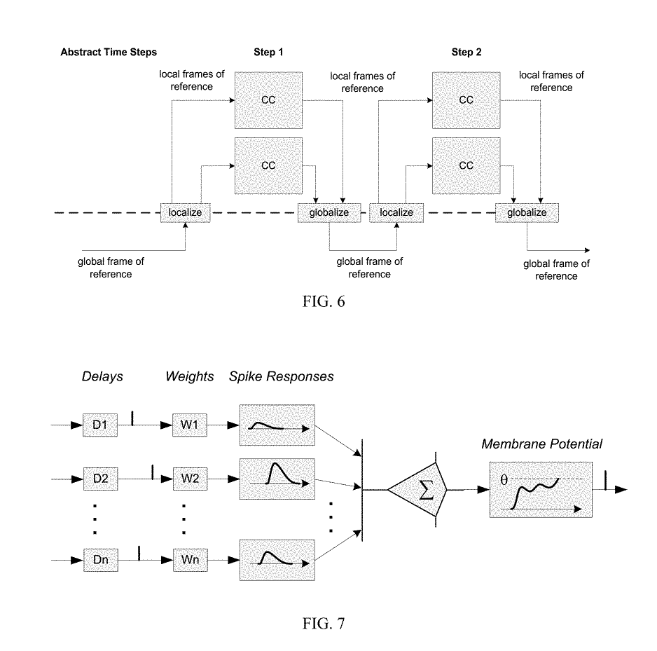

The way that time is modeled in the claimed invention can now be explained via FIG. 6. The dashed line separates upper and lower abstraction layers. Below the dashed line, actual spike times are maintained using a single, global frame of reference. The spike times are relative to a single specified time reference and are not required to be in normalized form. The specified time reference can be t=0 permanently, or the global reference time can be adjusted when going from one network layer to the next.

At each step, spike volleys destined for a specific CC are placed into their own normalized local frames of reference via abstraction (localization in FIG. 6), the CCs operate, and the output volleys are then placed back into a single global frame of reference (globalization in FIG. 6). Then, prior to the next CC step, the spike volleys that are going to be consumed by a CC are again placed into normalized local frames of references. They are then operated on by CCs at the next layer, etc.

By embedding the mechanisms that maintain a global frame of reference beneath the surface, their presence can be concealed from the higher level network designer. That is, one can work with a levelized computational model based on abstract time steps at the higher level, and the local temporal frames of reference are correctly supported by the underlying implementation infrastructure. Among other things, this means that all of the neuron models developed in this document are based on normalized input volleys.

For comparison, prior art conventional neural networks convert spikes to rates and use rates to encode information. Consequently, all communication and computation is based on spike rates. There is never a need to turn to actual spike times. However, with the rate encoding methods, actual spike timing relationships are lost and are not available for use during computation.

An important capability of systems implemented as SNNs is the identification of similar data patterns (and distinguishing dissimilar patterns). A cluster is a set of patterns that have similar features. Features are indicated by the spike pattern making up an input volley fed to the SNN. An SNN may be used for grouping input patterns into clusters so that the output(s) of the SNN indicate the cluster to which a given input pattern belongs. Similar input patterns (and input volleys) should result in similar output volleys, and dissimilar input patterns should result in dissimilar output volleys. This is accomplished by first training the SNN with a set of representative patterns (encoded as volleys) in order to determine the “natural” clusters, and then evaluating new patterns to determine the cluster to which they belong.

A related task is classification, where training patterns have labels which indicate a pre-specified cluster (or class) to which a given training pattern belongs. Then, after training, arbitrary patterns can be evaluated by the SNN to determine the class to which they belong.

Because externally supplied labels are part of the training process for classification, this type of training is referred to as supervised training. The labels identify the class to which a given input pattern belongs. In contrast, forming clusters without the benefit of labels is unsupervised training.

A model spiking neuron as shown in FIG. 7 is the basic computational component in an EC. For the purpose of modeling, the synapses on input lines are associated with the neuron body that they feed. That is, a modeled neuron includes both the neuron body and the synapses. All of the delays associated with an individual path between two neurons are lumped together in the input delays. Note that there may be multiple paths between two neurons.

The neuron is modeled with a simple version of the widely-used (Spike Response Model) SRM, the SRM0 model [Gerstner, W., and W. M. Kistler, Spiking Neuron Models: Single Neurons, Populations, Plasticity, Cambridge University Press, 2002.]. Refer to FIG. 8. In response to an input spike on a line feeding one of the synapses, the model first generates a waveform (a function of time); this waveform is the spike response. In biological terms, the spike response is the change in neuron body's potential (voltage), as a function of time, due to the input spike. For excitatory neurons (as are being described here), the spike response is the Excitatory Post Synaptic Potential (EPSP).

Because a modeled neuron contains multiple input synapses, a summation unit adds the EPSPs linearly (FIG. 7). At the time the sum of the spike responses first reaches a threshold value (denoted as θ), the neuron emits an output spike. If a sum of EPSPs does not reach the threshold value, then there is no output spike.

In the model considered there, a single volley can contain at most one spike per line (either on an input line or output line). Consequently, the biological refractory time following an output spike does not have to be modeled. Before each input volley, it is assumed that the value of the neuron's body potential is quiescent (initialized at 0).

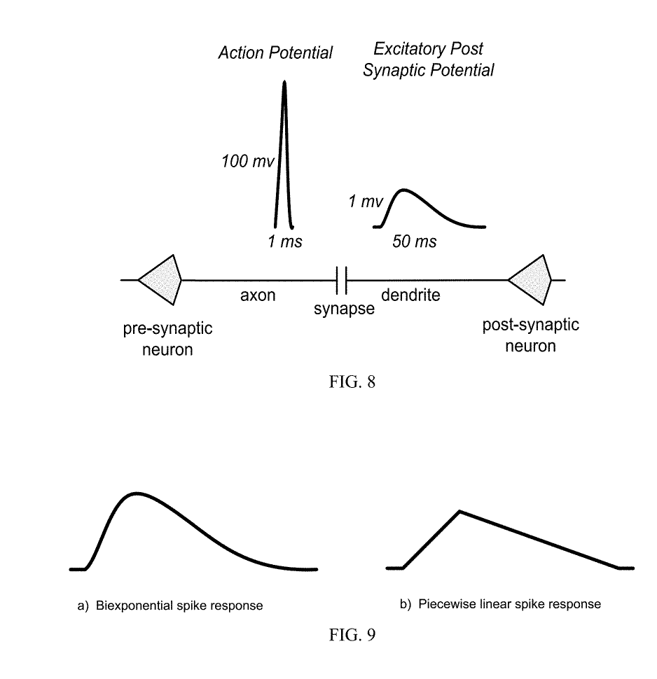

A fairly broad family of spike response functions (EPSPs) may be used. Two examples are shown in FIG. 9. On the left of FIG. 9 is a biexponential f(t)=K(e^{-t/τ1}−e^{-t/τ2}). On the right of FIG. 9 is a piecewise linear approximation of the biexponential. These are but two examples from a very large class of unimodal functions that: 1) evaluate to zero up to some initial time, 2) rise monotonically to a peak, and 3) then fall monotonically back to zero. The biexponential response function is one such unimodal function that leads to efficient digital implementations.

The biexponential response function contains two time constants τ₁ and τ₂. Although a wide range of time constants could be used, τ₁=20 msec and τ₂=5 msec are within the biologically plausible range.

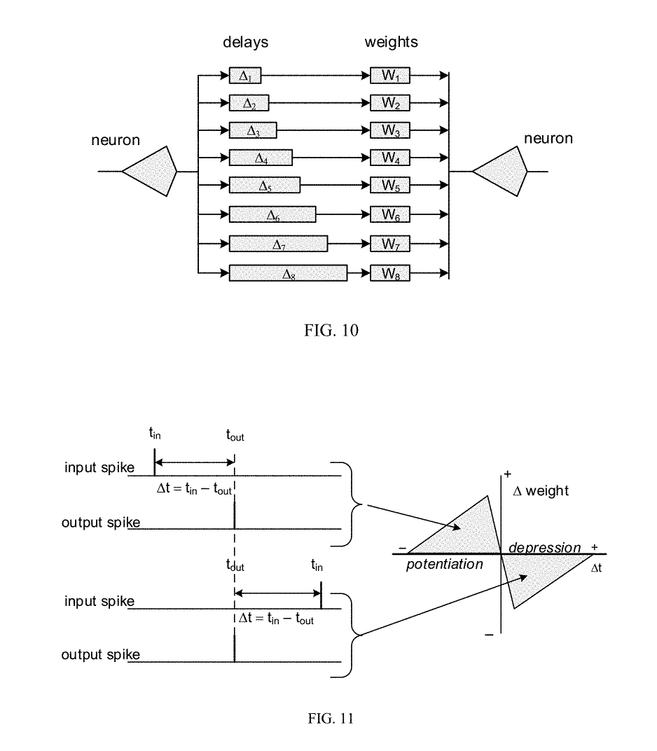

Each input connection from one neuron to another may fan out and follow multiple paths from the source neuron to the destination neuron body. This is illustrated in FIG. 10. Each of the multiple paths has an associated delay (Δᵢ in FIG. 10) and weight (Wᵢ in FIG. 10). The collection of paths from one neuron to another is a compound connection. The individual paths are simple connections. The collection of all the synapses belonging to the same compound connection form a compound synapse. The individual synapses are simple synapses.

The simple synaptic weights are typically assigned in the range between 0 and 1, although this is not a requirement; the upper and lower limits of the range may be any non-negative values as long as the lower limit is less than the upper limit. The weights establish the amplitudes of the individual spike response functions. Because a compound connection has multiple synapses, the aggregate weight of a compound synapse may be greater than one. For example, if there are eight paths (and eight simple synapses), the total effective weight of the compound synapse may be as high as eight if individual synapses have weights up to one.

In this model, delays are associated with the individual simple synapses which make up a compound synapse. The delays may be assigned values at fixed intervals over a specified range or they may be assigned according to some statistical distribution. In examples that follow, the synaptic delays belonging to a compound synapse span a range at fixed intervals.

A compound EPSP is the summation of the individual simple EPSPs on multiple paths. The combinations of multipath connections, where the paths may have different synaptic weights and delays, define a very large set of potential compound EPSPs.

The design challenge is to assign certain combinations of weights such that the neuron implements useful functions. An important aspect of the excitatory neuron model is the way that the weights are established; that is, the way the synapses are trained (and consequently the neuron as a whole). The claimed invention establishes the weights as part of the training process.

For training, the model incorporates a version of conventional spike timing dependence plasticity (STDP). The reasoning behind STDP is that if an input spike (from a pre-synaptic neuron) occurs a short time interval before an output spike (emitted by the post-synaptic neuron), then the associated synapse should have its weight increased (potentiated) because the input spike contributed to the production of the output spike. In contrast, if an input spike occurs after the output spike, then its weight should be diminished (depressed). This general concept is illustrated graphically in FIG. 11.

The specific rules for updating synapse weights due to spike timing relationships are the synaptic update rules. As suggested in [Morrison, Abigail, Markus Diesmann, and Wulfram Gerstner. “Phenomenological models of synaptic plasticity based on spike timing.” Biological cybernetics 98, no. 6 (2008): 459-478.], synaptic update rules may consist of two parts, a time dependent part and a weight dependent part. As shown in FIG. 11, define Δt=tᵢₙ−tₒᵤₜ where in is pre-synaptic spike and out is post-synaptic spike. Then, the positive change in weight (update rule) is Δw⁺=F+(w) G (Δtime) if Δt is negative and the negative change in weight Δw⁻=F(w) G (Δt), if Δt is positive. So, the update rule for the weight is the product of a function of the weight before update (F) and a function of the time difference between the pre-synaptic spike and the post-synaptic spike (G).

Continuing on, F−(w)=λw^{μ} and F+(w)=λ(1−w)^{μ}, where λ<<1 is the learning rate, and μ can take on a range of values. For the (1−w) factor in F+ it is assumed that the maximum value of w is 1. Two important cases are μ=0 which leads to an additive rule, and μ=1 which leads to a simple multiplicative rule. That is if μ=0, F(w) is a constant, regardless of the value of w before update. If μ=1, the change is smaller if the weight is closer to one before update (and larger if the weight is closer to 0). Note that F and G are multiplied, and λ is multiplied by their product; consequently, in a specific hardware or software implementation, λ can actually be associated with either F or G. The G functions (for + or − values of Δt) may be defined as exponential decays: G+(Δtime)=e^{-|Δtime|/τ+} and G−(Δtime)=e^{-|Δtime|/τ-}, or they may be piecewise linear approximations, or any other functions with similar shape.

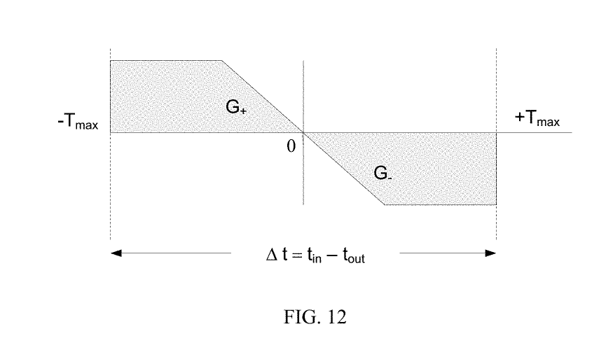

One preferred embodiment of a piecewise linear G function is illustrated in FIG. 12. This particular function may be used when processing is separated into distinct volleys were all the spikes in a volley occur with a coding window (size Tₘₐₓ or Vₘₐₓ). In other words, all spikes in a given volley that precede an output spike may cause potentiation, and all spikes in the volley that follow an output spike may cause depression. In the model, parameters specified by the designer determine the slopes and amplitudes of this piecewise linear function.

Unsupervised training is useful for finding similar patterns (clusters) in a set of training patterns (represented as volleys). After training, an evaluation pattern can be applied to the trained network to determine the cluster of training patterns with which the pattern being evaluated is most similar. The following method of unsupervised training may be used in CCs containing neurons with some structural variation among the neurons (e.g. in the delays and/or connectivity).

Training and evaluation involve the application of sequences of volleys. A volley sequence or volley train is denoted with an underscore; e.g., A. A volley train is essentially a vector of vectors (or a two dimensional array). One dimension consists of individual volleys (each composed of a number of spikes); the other dimension consists of an ordered set of volleys. A volley train used for training a CC will typically be referred to as a “training set”, and a volley train representing patterns to be evaluated after training is an “evaluation set”. Note that as used here, and in common usage in this field, the term “train” has two meanings depending on context. A volley train (as a noun) is a sequence of volleys; to train (as a verb) is the process of modifying the weights. Also note that because volleys represent patterns; the terms “volleys” and “patterns” will sometimes be used interchangeably in this document.

In one implementation of training, all weights are initially set at zero. The first volley of the training set is applied, and an output spike is forced at all neuron outputs with a spike time close to, and before, the maximum time Tₘₐₓ. This will cause the weights associated with synapses receiving a spike from the training volley to be incrementally potentiated. The process continues for subsequent training volleys. The sequence of training volleys is applied repeatedly until, eventually, the weights for a given neuron reach a critical point, at which time the neuron will begin to spike on its own according the neuron model (the neuron's output spike will occur before the forced one). And, at that point, the neuron's weights will continue learning the volleys being applied and the weights will eventually reach a statistical steady state. Getting this behavior to occur may require adjustment of the update rule parameters to reflect the properties of the training set. Note that in some cases, a neuron may never reach the critical point where it starts to spike on its own; in practical cases at least one of the neurons in the column should begin to spike.

This process will converge to the same set of final weights, regardless of the initial weights; that is, they can be initialized to random values, or set to any value between 0 and 1. If the weights are set to all 1s (maximum values), then it is not necessary to force output spikes; the neurons will begin spiking on their own.

However, if weights are initialized to nonzero values and if the training set happens to have no volleys with spikes on a given input line (or very few spikes on a given input line), then the weight for a synapse connected to that input line may not change significantly from its initial nonzero value. Then, after training, when applying an evaluation volley, if that particular input happens to receive an input spike, the spike may be weighted at a value that is not representative of the training set. An input line receiving no spikes during training is probably a pathological case in most systems, but it could theoretically occur.

With supervised training, individual neurons (and their associated synapses) are trained to emit an output spike for only a subset of the training volleys. In this case, not all the neuron outputs are forced to spike for every volley during the initial stage of training; only those neuron outputs selected to spike for a particular training volley are forced.

Consider the example of a classifier that is being trained to select from among a set of classes. A training input set has a label associated with each input pattern; the label indicates the class to which the input pattern belongs. If each class has a neuron assigned to indicate that class (for example a 1-out-of-N code for N classes), then only the single neuron associated with the class label is forced to spike as training begins.

An example is a classifier for handwritten numeral (as in the MNIST benchmark [LeCun, Yann, Léon Bottou, Yoshua Bengio, and Patrick Haffner. “Gradient-based learning applied to document recognition.” Proceedings of the IEEE 86, no. 11 (1998): 2278-2324]) with ten outputs (each indicating a digit of 0 through 9). One would apply one of the input patterns, say for the digit 3, and force the output of (only) neuron #3 to spike prior to Tₘₐₓ.

In general, if it is desired that a set of neurons in an EC should provide a specific (multi-spike) output response to a given training volley, then only those neurons contributing a spike to the desired output pattern should be externally forced to spike when the training input is applied. Eventually, as in the unsupervised case, the neuron should begin to spike on its own, with a spike time prior to the forced spike (and the forced spike no longer occurs). In cases where the neuron never begins to spike on its own, then neuron parameters may be adjusted for proper training; for example, by lowering the threshold.

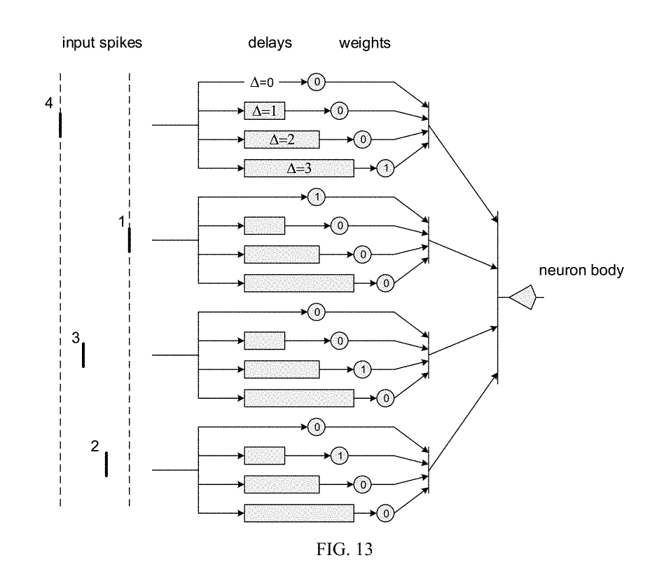

During training, the individual weights in a multipath connection tend to distribute themselves according to a certain pattern (for an example, see FIG. 13). In FIG. 13, the delays are in rectangles labeled with Δ, and the length of the rectangle indicates the size of the delay. Weights are given in circles that follow the weights. In particular, if the simple synapses belonging to a compound synapse are arranged top-to-bottom in order of increasing delay (shortest delay first), then the weights will settle at values of the general form <111 . . . 10 . . . 00> as shown in FIG. 13. That is, weights associated with shorter delays will be 1 up to some transition point, after which weights associated with longer delays will be 0. At the transition point, one (or a small number) of the simple synapses may have weights between 0 and 1, with the weights decreasing from shorter to longer delays. Depending on the spike times in the training pattern, the transition from 1 to 0 may occur early (if the spike time in the training pattern occurs late) or the transition may be later (if the spike time in the training pattern occurs early). In this example, say that the training volley is X=<4,1,3,2>ᵥ. Then, if the threshold is properly chosen (for example, a value of 8 to 9), the synaptic weights shown in FIG. 13 will be achieved as a natural stabilization process. In particular, the weights for input value 4 are <1,1,1,1>, for input value 1 the weights are <1,0,0,0>.

This type of trained weight behavior is important for the desired operation of the model neurons, and this is what sets it apart from other methods using multipath connections (such as radial basis function neurons, described later). The stabilization phenomena at work are described in [Guyonneau, Rudy, Rufin VanRullen, and Simon J. Thorpe. “Temporal codes and sparse representations: A key to understanding rapid processing in the visual system.” Journal of Physiology—Paris 98 (2004): 487-497]. Stabilization works as follows:

“for one given input pattern presentation, the input spikes elicit a post-synaptic response, triggering the STDP rule: synapses carrying input spikes just preceding the post-synaptic one are potentiated while later ones are weakened. The next time this input pattern is re-presented, firing threshold will be reached sooner which implies a slight decrease of the post-synaptic spike latency. Consequently, the learning process, while depressing some synapses it had previously potentiated, will now reinforce different synapses carrying even earlier spikes than the preceding time. By iteration, it follows that upon repeated presentation of the same input spike pattern, the post-synaptic spike latency will tend to stabilize at a minimal value while the first synapses become fully potentiated and later ones fully depressed.”

However, an important differentiating feature between the networks described in this document and the prior work just cited is that in the prior work, multipath (compound) connections are not considered. With only simple connections there is no ability to implicitly adjust delay characteristics on a per line basis as is the case with compound connections described here.

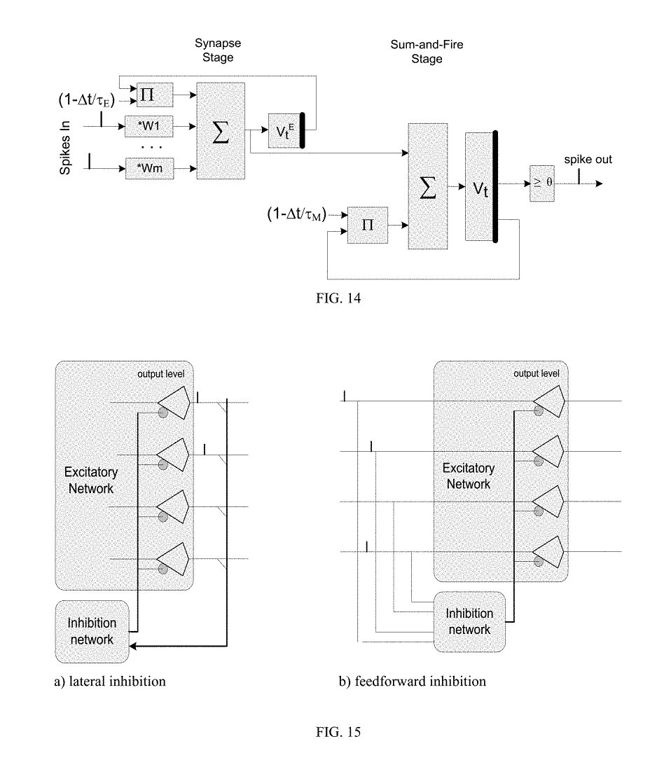

The block diagram for implementation of an excitatory neuron (as just described) is shown in FIG. 14. The implementation uses a discretized, fixed point version of the biexponential response function (see [Smith, James E. “Efficient Digital Neurons for Large Scale Cortical Architectures.” In Proceeding of the 41st Annual International Symposium on Computer Architecture, pp. 229-240. IEEE Press, 2014]). The delays are not explicitly shown, and are assumed to be implemented in the neuron interconnection structure (although they are associated with the synapses).

The illustrated block diagram in FIG. 14 may be implemented in custom logic, programmable logic, or it may be implemented strictly via software on a general purpose or special purpose programmed processor. A software implementation would use the block diagram as a flow chart, while a hardware implementation would use logic components to implement the blocks.

For millisecond spike volley precision, the simulation time step of 0.1 msec is likely sufficient. One feature of the implementation is simple, low precision fixed point arithmetic, although in a software implementation floating point arithmetic may be used for convenience. The neuron implementation also has the property that execution time is dominated by two multiply-adds and a comparison per simulation cycle. The multiplications have one constant operand (and therefore may be specialized if desired). Note that the conceptual weight multiplications at the spike inputs are actually select functions (multiplications by 0 or 1, because the spike values are either 0 or 1). There is a fixed computation for each spike, but the number of spikes (in a sparse situation, especially) will be relatively small, so that the computation is dominated by the two multiply-adds per cycle per neuron.

Thus far, the description has centered on excitatory neurons. However, in the biological system, and in the SNNs described here, there are also inhibitory neurons which have the opposite effect of excitatory neurons. Their Inhibitory Post Synaptic Potentials (IPSPs), may be a negative reflection of the EPSPs. In a model, one could implement inhibition via individual inhibitory neurons implemented in a very similar manner to the excitatory neurons. However, as one alternative in the spiking neural networks described here, inhibition is implemented as a bulk process at a higher level of abstraction than excitation is modeled.

A purpose of inhibition is to reduce the number of spikes that a CC produces. Doing so may save energy and/or time (depending on the implementation). Also, because the first spikes are the most important (carry the most information), eliminating later spikes allows the spiking threshold to be reduced and the ability to discriminate different input volleys is enhanced.

FIG. 15 illustrates two important forms of inhibition. Lateral inhibition uses the initial spikes in an output volley from given column to inhibit the further operation (and spiking) of neurons belonging to that same column. Feedforward inhibition uses the spikes of an output volley to inhibit any further spikes from that column from going forward to the next column.

In this bulk inhibition model, both lateral and feedforward inhibition are implemented as a spike elimination process that is performed by an Inhibitory Column (IC) placed at the input or output of an EC (see FIG. 4). In a simple (and commonly used form), inhibition eliminates all but the first k output spikes of a time volley produced at the ECs outputs, where k is a specified parameter. This is typically referred to as k-winner-take-all (k-WTA), because only the first k spikes, the “winners”, are allowed to proceed to the next column.

Feedforward Inhibition: The important effect of feedforward inhibition (FFI) is to eliminate the downstream propagation of all spikes in a volley if the volley contains a relatively large number of spikes that occur very early and nearly simultaneously. Biologically, the large number of early spikes are propagated through fast spiking feedforward inhibition which chokes off the downstream EC before any of its neurons can produce an output spike (refer to FIG. 15b).

FFI is modeled with two parameters, t_{F} and k_{F}. If more than k_{F} spikes in a volley occur within time t_{F} of the first spike, then all spikes in the volley are eliminated (are “nullified”). Otherwise, all the input spikes are allowed to pass to the output, unchanged.

For a normalized volley input <t₁, t₂, t₃, . . . tₙ₋₁, tₙ>ₜ,

FFI (<t₁, t₂, t₃, . . . tₙ₋₁, tₙ>ₜ, t_{F}, k_{F})=<t₁′, t₂′, t₃′, . . . tₙ₋₁′, tₙ′>ₜ,

let L={tᵢ|tᵢ≦t_{F}}
then if |L|≦k_{F}, tᵢ′=tᵢ for all i;
else tᵢ′=“-” (no spike) for all i.

The generalization to unnormalized volleys is straightforward.

Examples:

FFI (<4, -, 6, -, 0, -, 1, 8, 5>ₜ, 2,2)=<4, -, 6, -, 0, -, 1, 8, 5>ₜ

FFI (<4, -, 6, -, 0, -, 1, 8, 5>ₜ, 2, 1)=<-, -, -, -, -, -, -, -, ->ₜ

Lateral Inhibition: The effect of lateral inhibition (LI) is to allow early spikes in a volley to propagate downstream to other columns, while eliminating later spikes from the volley (FIG. 15a). This is modeled via a single parameter t_{L} which specifies a time interval measured with respect to the first spike in a volley. With LI, only spikes occurring within time t_{L} of the first spike are included in the LI's output volley.

For a normalized volley input <t₁, t₂, t₃, . . . tₙ₋₁, tₙ>ₜ,

LI (<t₁, t₂, t₃, . . . tₙ₋₁, tₙ>ₜ, t_{L})=t₁′, t₂′, t₃′, . . . tₙ₋₁′, tₙ′>ₜ,
where tᵢ′=tᵢ if tᵢ≦t_{L}
otherwise tᵢ′=“-” (no spike).

The generalization to unnormalized volleys is straightforward.

Example:

LI (<4, -, 6, -, 0, -, 1, 8, 5>ₜ, 5)=<4, -, -, -, 0, -, 1, -, 5>ₜ

Classification is an important component of many neural computation systems; in some cases, it is the purpose of the entire system. The description here is centered on a single CC classifier; larger, hierarchical classifiers will be described later.

If there are N classes, then the CC classifier contains N neurons, one associated with each class. Using labels associated with the training data, the N output neurons are trained in a supervised manner to spike for the class indicated by the label.

After a classifier has been trained (the synapse weights have been established), arbitrary input patterns may then be evaluated to determine the class to which they belong, that is, the class with which the evaluation pattern is most similar.

To better understand the significance of the SNN classifiers as implemented with the claimed invention, it is useful to first consider important related prior work in some detail: classifiers based on Radial Basis Function (RBF) neurons [Natschlager, Thomas, and Berthold Ruf. “Spatial and temporal pattern analysis via spiking neurons.” Network: Computation in Neural Systems 9, no. 3 (1998): 319-332].

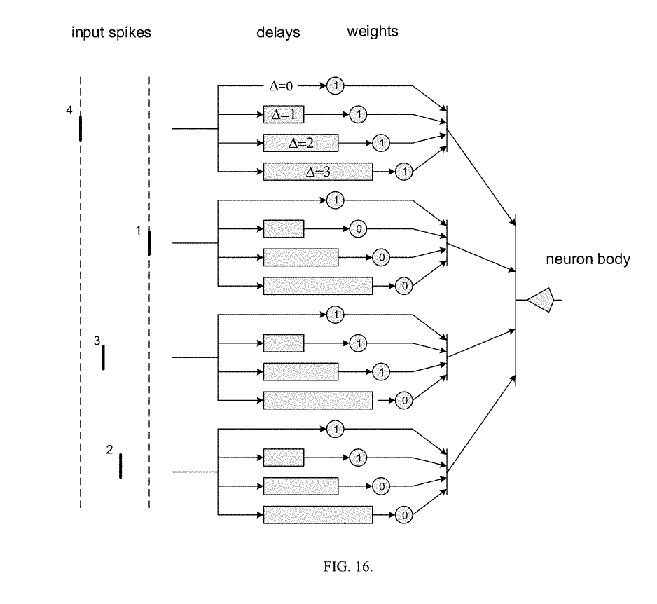

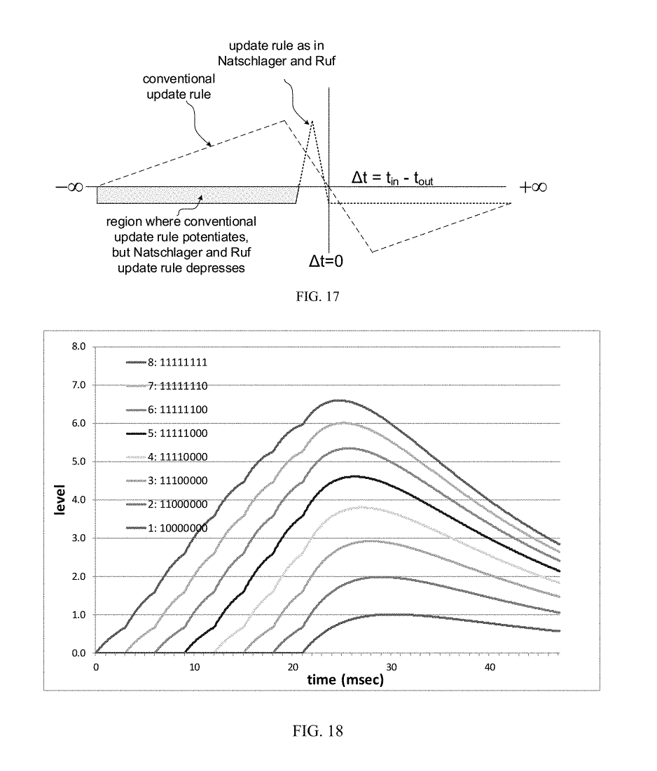

The structure of the multipath model used in RBFs is similar to the one used in the claimed invention. The very important major difference is in the STDP update rules. The main idea behind RBF neurons is that synaptic weights are adjusted through training so that the delays along the compound connections match a set of training patterns. This is illustrated in FIG. 16.

In the example, the four delay values for each of the compound synapses are <1,2,3,4> (as labeled in the top compound synapse). In the example, the input spike volley is illustrated with the spikes in time, and the labels are the corresponding values. For example, the first spike, at t=0 has the value 4. The last spike at t=4 has the value 1. The value volley is <4,1,3,2>ᵥ. The upper compound synapse has a weight=1 for the longest delay (4), and the other weights are 0. The assigned weights select the delays in such a way that at the neuron body, the compound EPSPs will all be aligned in time if an evaluation volley matching the training volleys(s) is applied at the inputs.

In general, RBF neurons may have more than one synapse with non-zero weight, but all the non-zero weight synapses are confined to a narrow range. Hence, the objective in the RBF neuron approach is to train the synapses so that a single synaptic delay (or a narrow band of synaptic delays) is selected (are assigned nonzero weight), and the other synaptic delays on either side of the band are not selected (are assigned zero weights). Refer to FIG. 16. The most important feature of the RBF rule in [3] is that there is only a narrow time region (about 3 msec in FIG. 16) where a synapse is potentiated (the value of the update rule is greater than zero). Everywhere else, the update rule causes depression (the update rule is less than zero). In particular, there is a region where the input spike precedes the output spike, yet the RBF update rule causes depression. For this situation a conventional STDP update rule, as used in the claimed invention, will cause potentiation.

The synaptic weight update behavior in the RBF neurons runs counter to conventional biologically-based principles in two ways:

1) The RBF update rule is quite unlike conventional, biologically-based STDP. As just stated, there is a region where the RBF update rule and a conventional STDP rule oppose each other regarding potentiation and depression.

2) When it comes to learning a temporal spiking pattern, the RBF update rule effectively gives equal importance to all the input spikes, regardless of their time order. This property of the RBF update rule is not consistent with the principle that the first spike of a trained pattern is most important (and should therefore carry the most weight).

In contrast to the prior art RBF neurons as just described, in the claimed invention, the trained weights for a neuron using a more conventional STDP update rule as is proposed here, are of the form <11 . . . 100 . . . 00> (illustrated and described earlier with respect to FIG. 13.). That is, the simple synapses with shorter delays all have weight 1, then there is a threshold delay after which longer delays all have weight 0 (although there may be a short transition region where weighs are between 0 and 1). In the idealized case, the first spike in time (highest value) will have a weight vector of <111 . . . 11>, and the latest spike in the volley (lowest value) will have a weight vector with only one or a few leading ones; for example, <100 . . . 0>.

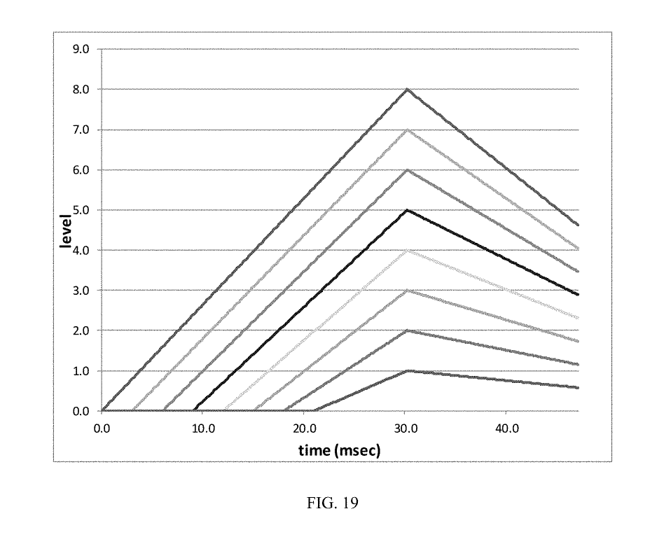

With weight assignments of the form general <11 . . . 100 . . . 00>, the characteristics of the resulting compound EPSPs are illustrated in FIG. 18. These waveforms provide the basis for a new, higher level model of neuron behavior that is part of the claimed invention. The higher level model captures the behavior of a compound EPSP without requiring the explicit summation of its constituent simple EPSPs. FIG. 19 illustrates a piecewise linear approximation of the example compound EPSPs shown in FIG. 18. This approximation has the same key characteristics of the compound EPSPs.

Excitatory neurons with compound synapses are the basic computational elements of a high level EC described in this document.

In the claimed high level EC with m input lines and n output lines (n neurons), there is a weight associated with each input-output pair ij. Because simple synapses have been combined to a single path in the high level model, a weight in the high level model is essentially an aggregate weight that captures the properties of the compound weight. For neuron j, the weight vector Wⱼ<=w₁ⱼ, w₂ⱼ, . . . Wₙⱼ>, 0≦wᵢⱼ≦Wₘₐₓ. Because this single abstract weight represents the aggregate weight of a compound synapse with c simple connections, and the weights for simple synapses are typically between 0 and 1, then one may choose Wₘₐₓ=c, although this is not required.

As just defined, all m of the input lines are connected to all n neurons. However, by defining the weights on some ij connections to be 0, a partial connection of input lines may be effectively achieved. That is, the inputs with nonzero weights are connected and the inputs with zero weight are essentially disconnected because they can have no effect on the output. Nevertheless, in some implementations, it may be simpler to eliminate connections having 0 weights.

As specified above, a neuron takes as input normalized volleys containing spikes having times between 0 and Tₘₐₓ. The neuron produces a single output spike which can take on a range of values that depends on a number of factors to be described later. Tₘₐₓ and Wₘₐₓ are related via the scale factor γ=Tₘₐₓ/Wₘₐₓ. That is, γ is the ratio of the maximum range of input values to the maximum range of spike times. Because Tₘₐₓ=α⁻¹ Vₘₐₓ, it follows that γ=α⁻¹ Vₘₐₓ/Wₘₐₓ.

The neuron producing the output on line j implements the function S, so zⱼ=S(X,W), where the input volley X can be either a value volley or a time volley. However, the following description is based on time volleys. The function S, in turn is defined via a number of parameterized response functions, fᵢ(t,wᵢ), to be described below. The parameters will be defined below as they are introduced.

The weight w on input line i defines the parametric response function fᵢ(t,wᵢ). Because only a single neuron is being considered initially, a single input subscript is sufficient for identifying w.

In general, there is a broad class of possible functions suitable for fᵢ. The unimodal function fᵢ(t,wᵢ) is defined as follows in terms the scale factor γ and two additional parameters Tᵣ and T_{f}, 0<Tᵣ<T_{f}. Typically, T_{f}≧2Tᵣ, but this is not a requirement.

| | |
|---|---|
| t < 0 | fᵢ = 0 |
| 0 ≦ t ≦ Tᵣ + γ(wᵢ − 1) | fᵢ rises monotonically until it |
| | reaches a maximum value of |
| | wᵢ at t = Tᵣ + γ(wᵢ − 1) |
| Tᵣ + γ(wᵢ − 1) ≦ t ≦ | fᵢ falls monotonically |
| | until it reaches |
| T_{f} + Tᵣ + γ(wᵢ − 1) | 0 at t = T_{f} + Tᵣ + γ(wᵢ − 1) |
| T_{f} + Tr + γ(wᵢ − 1) < t | fᵢ = 0 |

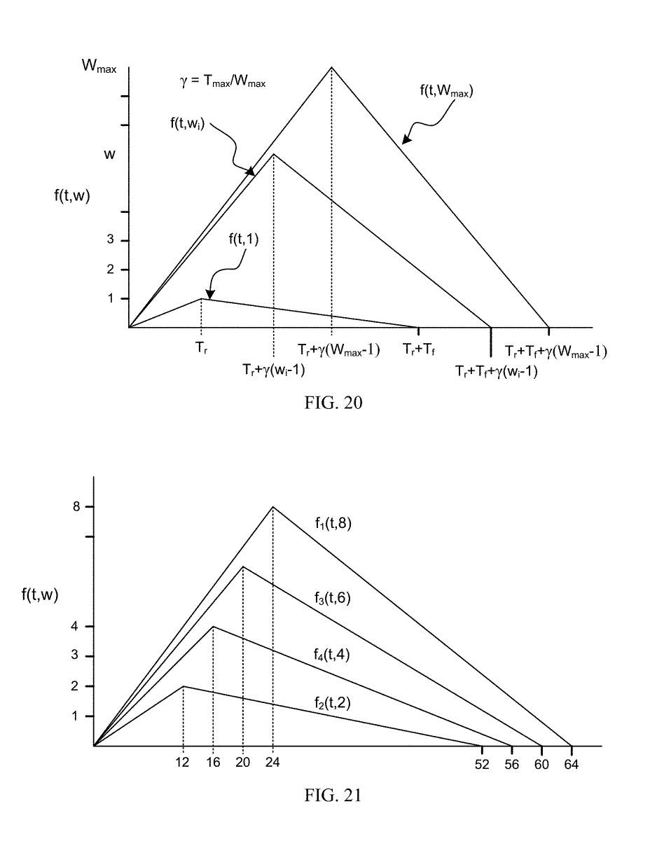

An example piecewise linear function having the above-defined properties is illustrated via three examples in FIG. 20. This is a preferred function for implementing neuron function S.

Neuron weights for the high level neuron model are established via training. The training process will be described later. First, the following description of functional operation assumes that training has been completed, and the weights have been established. This means that all the parametric response functions fᵢ are defined. After training the weights, and therefore the functions fᵢ, remain unchanged while input patterns are evaluated.

An input volley is applied to a trained neuron as a time volley X. An equivalent function for a value volley may also be used. Spike i has the associated time tᵢ. To evaluate the S function, first all the functions fᵢ(t−tᵢ, wᵢ) are evaluated; these are shifted versions of fᵢ(t). Then, the shifted functions fᵢ(t−tᵢ, wᵢ) are summed linearly to complete the process of forming the output function S. The function S is then evaluated to determine when its value crosses the threshold parameter θ. The least value of t for which the value of S equals or exceeds θ is the output value. If S never equals or exceeds θ then the output is defined to be “-” (the absence of a spike). Stated concisely, for an input volley T, and a weight vector W:

S(X,W)=min t|Σfᵢ(t−tᵢ,wᵢ)≧θ

else if there is no such t, S(X,W) is defined to be “-”.

Example: Say that the weight vector for a single neuron, after training is W=<8,2,6,4>, and Wₘₐₓ=8. Assume Tₘₐₓ=16, so γ=2. Given W, one can form the four response functions fᵢ. If Tᵣ=10 and T_{f}=40, the four functions are shown in FIG. 21. Using the properties of the response functions given earlier, f₁ is 0 for values of t less than 0. For values of t between 0 and Tr+γ(w₁−1)=10+2(8−1)=24, the function rises linearly until it reaches a maximum value of 8. Then it falls linearly until t=T_{f}+Tᵣ+γ(wᵢ−1)=64. Similarly, f₂ rises linearly to a maximum of 2 when t=10+2(2−1)=12. It then falls linearly until it reaches 0 when t=52. The functions f₃ and f₄ are also shown in the figure.

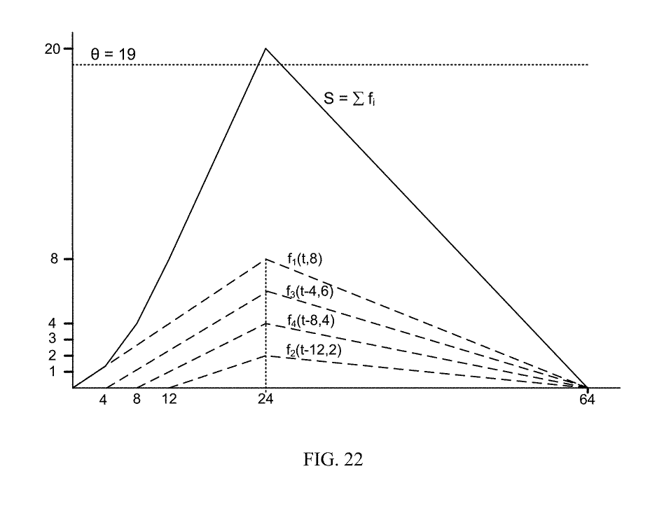

Continue the example by applying input volley X=<0,12,4,8>ₜ; that is, apply an input volley that is perfectly matched with the trained volley. Say the threshold θ=19. Then, the response functions are shifted by the values tᵢ; the shift amount for f₁ is =0. Similarly, for f₂, f₃, and f₄, the shift amounts are 12, 4, and 8, respectively. This yields the functions shown in FIG. 22. The sum of the response functions is also given in the figure. The sum peaks at f=20 and crosses the threshold when t=22.1. □

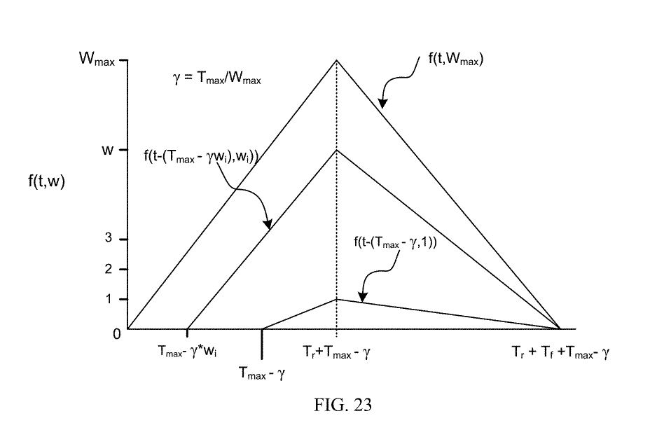

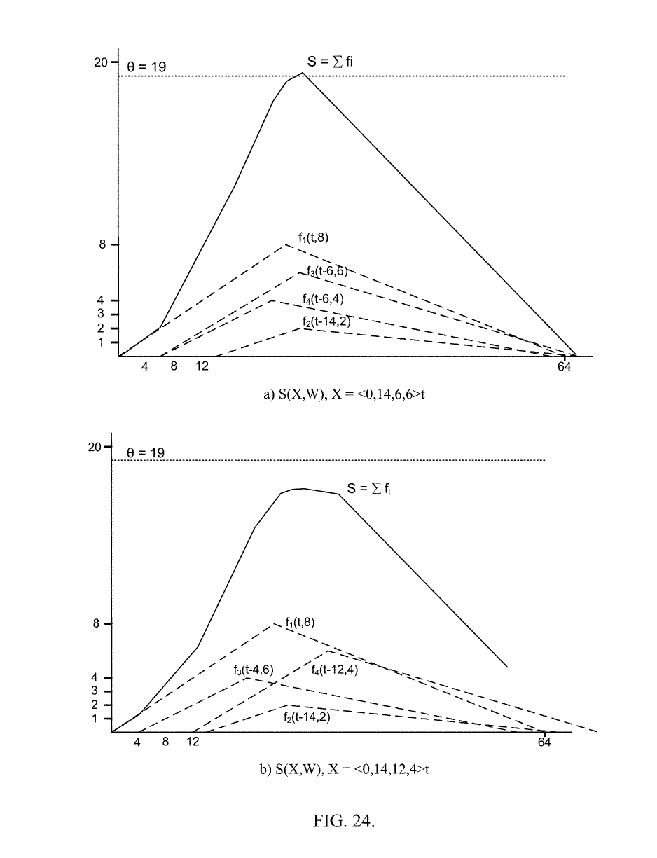

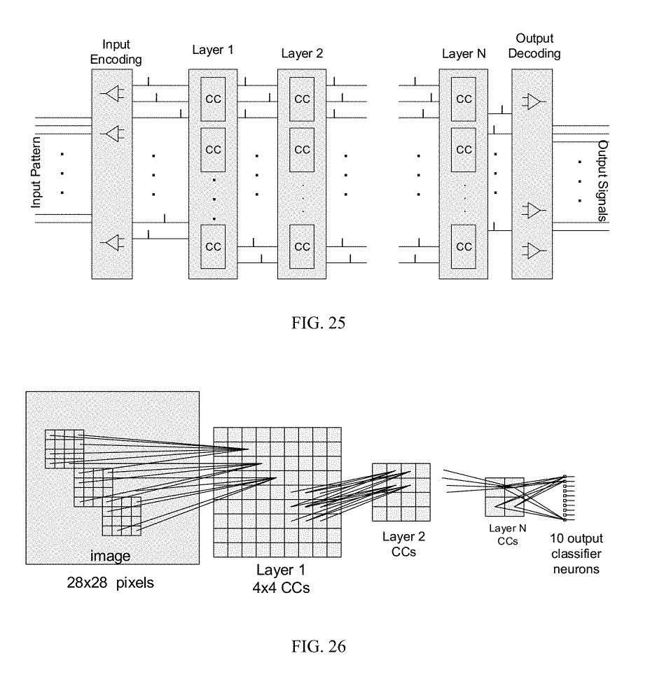

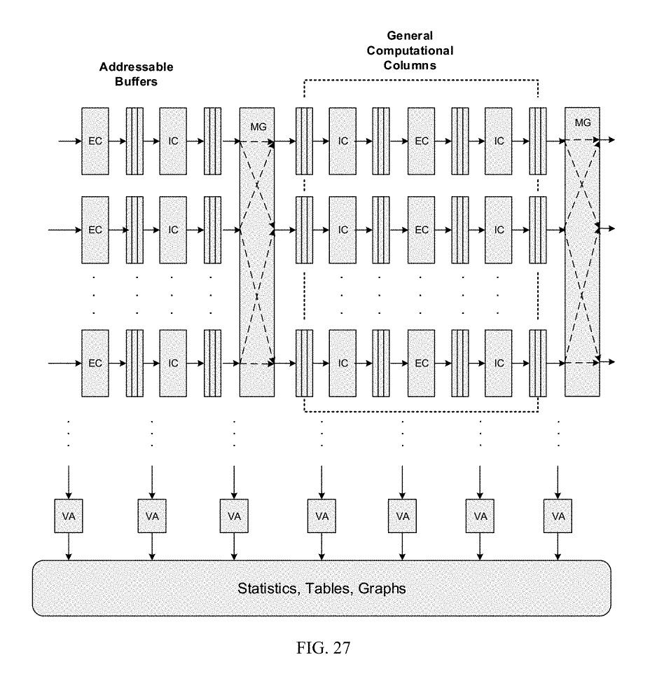

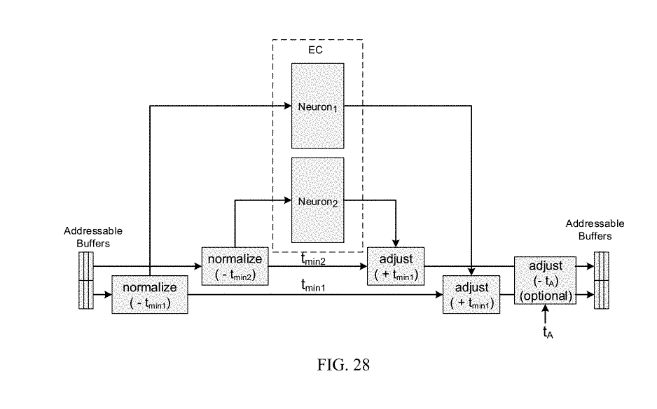

Observe that for the example just given, the maxima for all the functions align in time. If tᵢ=γ wᵢ then fᵢ(t−tᵢ,wᵢ) reaches its maximum value at Tᵣ+Tₘₐₓ−γ. That is, if the input pattern perfectly matches the trained pattern, the maximum value is the same for all inputs i where tᵢ=γ wᵢ. Because all the individual response functions reach their maximum at this point, so must their sum. This is a key property of the response function(s), and it is the rationale for defining them as they are. This is illustrated in FIG. 23.

Example: Consider other example input volleys. If X=<0,14,6,6>t, the response functions and their sum are in FIG. 24a. In this case, the sum S crosses the threshold at t=26. Finally, if the input volley X=<0,14,12,4>t, the response functions and their sum are in FIG. 24b. In this case the threshold is not crossed, so the output is denoted as—(there is no output spike). To summarize the examples, when the inputs match the trained weights, i.e. ti=γ wi, then the function S reaches a maximum value, and if the threshold is at or below this value, then the output will be non-zero. If the ti are close to the weight-matched value (as in FIG. 24a), then the S function will not go as high as the peak value, but it will still reach the threshold. Finally, if the ti are farther away from the weight matched values, then the threshold may not be reached and the output is 0 (as in FIG. 24b). In general, the closer the input volley is to the weight matched values the more likely it is to cross the threshold, and the lower the value of t where it does cross.

□

The combination of a number of neuron outputs into normalized volley form is what determines the final values of all the spikes in a volley.

Denote the times computed by the S functions as unnormalized Z^{p}=<t₁, t₂, . . . tₙ>ₜ. If any of the S functions results in no spike, it is denoted as “-” in the output volley Z^{p}. This is an unnormalized time volley. Let tₘᵢₙ be the minimum tᵢ. Then the normalized output time volley is Zⁿ=<t₁−tₘᵢₙ, t₂−tₘᵢₙ, . . . tₙ−tₘᵢₙ>ₜ.

As a degenerate case, a column may contain only a single neuron (with an output bundle containing a single line). By definition, this single spike output volley is normalized, so any preliminary output spike becomes z₁=Zₘₐₓ (0 or Vₘₐₓ), depending on whether a value volley or time volley is used.

Example: Assume there are trained four neurons in an EC, and for a given input volley, the neurons produce the unnormalized output values for S₁ . . . S₄ are <22, 23, 27, ->ₜ, respectively. The minimum time is 22, so the normalized output time volley Z=<0, 1, 5, ->ₜ. □

Thus far, the method for forming response functions has been described, and the threshold for generating an output spike has been defined. What remains is the actual method of computing the output spike times (values), given the response functions and the input volley.

It is assumed that time is divided into intervals ε. For example, ε=0.1 msec. Note that “time” is only used for intuitive convenience; what are referred to as “times” can actually be dimensionless quantities, just as the values are.

Generally speaking, c is determined by the precision required. For example, if the time parameters Tᵣ and T_{f} are measured in a few msecs to a few tens of msecs, then choosing ε=0.1 msec yields good precision in the computation of the output spike times.

One computation method is to simply step through time incrementally, one c time unit per step, calculating the function S. The threshold is crossed at time t, then the spike in the preliminary output volley is assigned to be t.

Another method which works for piecewise linear response functions is based on the observation that the sum of the response functions will be linear between any discontinuities in any of the component response functions. So, after an evaluation volley has been applied one can identify in advance all of the times where any of the response functions contains a discontinuity. These are the points where the rise time begins, where the response function peaks, and where the fall time ends. Given these “breakpoints”, one can evaluate the function S only at the breakpoints, as the breakpoints occur in increasing time sequence. If at breakpoint i, the threshold is first exceeded, then the threshold spike time must occur between breakpoint i−1 and breakpoint i. Then, solving a simple linear equation will yield the point at which the threshold is crossed.

The above are only two methods for determining when the threshold is crossed. The incremental method will work for any response functions; the breakpoint method for piecewise linear response functions. However, based on the characteristics of the response functions, other methods for determining when the threshold is crossed may be devised.

To summarize, the neurons that make up an excitatory column are fed by a set of compound synapses, where compound synapse has an associated weight. The weight defines a response function, based on the parameters given in Table 2.

TABLE 2
Summary of Parameters for Abstract Neuron Model

| | |
|---|---|
| Tᵣᵢₛₑ or Tᵣ | response function rise time when w = 1 |
| T_{fall} or T_{f} | response function fall time when w = 1 |
| Tₘₐₓ, | maximum time in a normalized time |
| Vₘₐₓ | volley; maximum value in a |
| | normalized value volley |
| | Vₘₐₓ = αTₘₐₓ, |
| Wₘₐₓ | maximum weight of a compound synapse |
| γ | Tₘₐₓ/Wₘₐₓ |
| θ | threshold |

In preceding description of the high level excitatory neuron model, it was assumed that the weights had already been determined through training. What follows is a description of the training process, itself. Training can be as simple as defining all the weights to be some constant between 0 and Wₘₐₓ. However, in most cases a more elaborate training scheme is appropriate.

Biological STDP is essentially an averaging process with a minimum amount of state being maintained. The state, and the way it is maintained, are most likely determined by biological constraints that are not present when constructing a computation model as is being done in this document. Consequently, training may be reduced to a conventional averaging process, using the arithmetic mean, for example.

For the types of training described here, it is assumed that there is no temporal information among different volleys belonging to the training set. That is, the information carried by one volley in a volley train is independent of information in any other volleys in the train. This implies that the volleys belonging to the training set can be applied in any random order, and the final weights should be more-or-less the same.

In general, if there should be some statistical inter-volley dependence, such cases may be handled by defining a sliding time window of some size, and keeping a running average over that interval. This implies that training occurs concurrently with evaluation.

A preferred scheme for unsupervised training, takes the average (arithmetic mean) value for each of the lines across the training volley set and then scales them so they fit within the maximum weight range defined by Wₘₐₓ. Scaling with the already defined ratio γ=Tₘₐₓ/Wₘₐₓ is the preferred approach for doing this, although one could scale in other ways, as long as the final weights are between 0 and Wₘₐₓ.

Denote the training volley set as R; then there are a total of |R| volleys in the training set. For a given input line i (which feeds a compound synapse), let tᵢ be the spike time within a given training volley. The weight associated with this spike is (Tₘₐₓ−tᵢ)/γ. The overall weight for the synapse associated with line i is then the average of the associated weights: Σ(Tₘₐₓ−tᵢ)/(γ|R|), where the summation is over all the volleys in the training set R. Equivalently, for value volleys, the incremental weight contribution is (Vₘₐₓ−vᵢ)/αγ, and the average synaptic weight for input line i is wᵢ=Σ(Vₘₐₓ−vᵢ)/αγ|R|.

With both unsupervised and supervised training, the training time is linear in the size of the network (measured as the number of synapses) and it is linear in the training set (measured in total numbers of spikes). This has the potential of being several orders of magnitude faster than conventional machine learning models.

For supervised training, specific neurons are selected for each training input volley. The selected volleys may be indicated directly or indirectly by labels associated with the volleys. To give one simple example, if an SNN as described here is analyzing hand-written digits 0-9, then one might implement a computational column with ten neurons, where each of the neurons is assigned to one of the ten digits. If an input volley is produced by one of the digits, then the corresponding neuron should be the first to spike, thereby indicating the digit presented at the inputs.

During training, if a given input volley is associated with a given digit, then only the neuron associated with that digit is trained for the input volley. That is, the input volley only affects the weights for synapses feeding the associated neuron.

Consequently, let Rⱼ be the set of training volleys for which neuron j should emit an output spike. The averaging equations are similar to those for unsupervised training, except that averaging is over the subset Rⱼ. w^{j}ᵢ=(Σ(Tₘₐₓ−tᵢ)*Wₘₐₓ/Tₘₐₓ)/|Rⱼ|, where the summation is over all the volleys in Rⱼ.

Unsupervised training can be performed as a separate phase from evaluation, or it can be performed concurrently. That is, one may first apply the set of training volleys, establish the weights (and response function), and fix them at those values. Then, evaluation volleys are applied, with no changes to the weights. Alternatively, training can occur concurrently with evaluation. In this case, the training set is open-ended, and one can keep a running-average of the weights, using some type of bounded time window. Or, one could use a method akin to STDP, where an average is adjusted based on an update function similar to the conventional STDP update functions.

A feature of inhibition when used with conventional STDP is that weight updates only occur for those neurons with output spikes that are not inhibited. That is, for a weight update to occur, whether positive or negative, there must be an output spike.

The effect of this feature on training may be approximated in the high level model in the following way. First, the training volleys are applied and unsupervised training is performed. Then, the weights are (temporarily) fixed at the trained values and the training set is applied again; this time, the output volleys pass through inhibition and all non-inhibited spikes are captured in a set of output volleys called label volleys. Finally, the training volleys are applied a third time, this time with supervised training using the newly-formed label volleys to control training. That is, a neuron's weights are adjusted only if the label volley has a spike corresponding to that neuron. The weights determined during this final training step become the weights used for evaluation.

In this way, the naturally occurring (unsupervised) uninhibited spikes are re-enforced during the third step, while the later inhibited spikes receive no re-enforcement.

As illustrated FIG. 6, a system architecture is composed of interconnected CCs. In that figure, the CCs are connected in a feedforward manner; given the orientation of the figure, spike volleys always flow from left to right. There is no feedback; that is, no volley to the right feeds a CC to the left. Furthermore, the CCs in FIG. 6 are levelized. That is, they can be divided into distinct levels or layers, which, if numbered from left to right, a CC at layer i only provides an input volley for layer i+1. The primary input volleys for the system conceptually occur at layer i=0.

In this document, levelized, feedforward CCs receive most of the attention. However, it should be clear that the CCs described here could also be used in a non-levelized manner and/or with feedback. If volleys are applied to such a non-levelized network, then the volleys from different input steps may be combined. This is important if there is some time-dependent information among successive volleys (for example in successive video frames).

FIG. 25 is a block diagram of a levelized feedforward architecture. It is composed of a number of layers, each consisting of some number of parallel computational columns (CCs).

The first layer of the system, labeled Input Encoding, is not a computational column. Rather, it is an optional layer that takes input patterns in whatever form they may initially be and converts them to spike volleys. As one example, the input could be visual images. These images may undergo some form of filtering or edge detection, with the output of the translation stage as spike volleys.

One way that input patterns may be represented is with values for which there is a linear ordering. For example, the pattern could be a set of voltage levels, sound levels, intensity levels from touch, stock values, etc. Another example is simple gray scale images where the lighter the pixel value, the higher the value (and conversely, the darker the pixel, the lower the value). For this type of ordered input, a general method for translating to spike volleys is now described.

If there are a total of n input elements (e.g., pixels in a grayscale image), then the value of each of the elements is translated into to spikes belonging to a volley. stage. Say the n input values are denoted with vector I=<i₁, i₂, . . . iₙ>, 0≦iₖ≦Iₘₐₓ. The input vector is first normalized using the method describe earlier so that at least one of the input elements is 0. Then an input volley X=<xᵢ, x₂ . . . xₙ, xₙ₊₁, . . . x₂ₙ> is formed from input I. Note that the volley X has twice the number of elements as input vector I. Furthermore the x values are organized in pairs so that xₖ is paired with xₙ₊ₖ. Define: ˜iₖ=Iₘₐₓ−iₖ.

Then, expressed as a value volley, xₖ=iₖ*(Vₘₐₓ/Iₘₐₓ), and xₙ₊ₖ=˜iₖ*(Vₘₐₓ/Iₘₐₓ). Note that the value volley thus formed may further be scaled or normalized as a final step of the translation process.

Example: Given an input vector with values I=<1, 8, 3, 0>, following is the formation of the input volley X. The scaled input and its multivalued complement <7, 1, 5, 8> are concatenated to form the input volley X=<1, 8, 3, 0, 7, 1, 5, 8>ᵥ.

| | k = 1 | 2 | 3 | 4 | n + k = 5 | 6 | 7 | 8 |
|---|---|---|---|---|---|---|---|---|
| xₖ | 1 | 8 | 3 | 0 | | | | |
| x₂ₖ | | | | | 7 | 1 | 5 | 8 |
| X | 1 | 8 | 3 | 0 | 7 | 1 | 5 | 8 |

As an alternative method, which results in a less dense input volley X, all the scaled inputs with a xi<Vₘₐₓ/2, can be removed (replaced with a “-” in the value volley). For the example just given above, Vₘₐₓ=8, so the alternative sparser encoding is <-, 8, -, -, 7, -, 5, 8>ᵥ. This encoding is no longer guaranteed to be unordered with respect to other code words, but only the half of the values with lower values have been removed, resulting in little information loss. Furthermore, in many cases most of the code words remain unordered.

The desirable feature of this translation scheme is that it results in a temporally unordered spike volley which will now be described.

A normalized value volley X¹ covers normalized volley X², written X¹≧X² if xᵢ¹≧xᵢ² for all i. For purposes of ordering, 0≦“-”. With an unordered code, no two code vectors satisfy the covering relationship. The covering relation for a time value is similarly defined, given the linear transformation between value and time volleys.

As has been stated, similar spike volleys represent similar input data patterns. If each class or cluster is based on a similar encoding, then different classes or clusters tend to be more readily separated if unordered codes are used (although this is not strictly required). If the encoding for one class covers the encoding of another, then any time a neuron produces a spike for the covered encoding, it will very likely produce a spike for the covering encoding. This is due to the threshold spiking behavior of the neurons This behavior will tend to increase the likelihood of a CC producing similar output spike volleys for two different classes or clusters, which is counter to the objective of having dissimilar output spike volleys for different classes or clusters.

Following input encoding, subsequent layers of computational columns process the spike volleys using the methods described earlier.

Continuing with FIG. 25, the Output Decoding layer takes spike volleys as inputs and translates them into desired signals at the systems output. These signals could be as simple as indicating a class to which the input belongs, or they could be activation signals that control some electro-mechanical device.

As an important special case spiking neural network system, multi-layer, hierarchical classifiers now described. For illustrative purposes, the MNIST benchmark set, cited earlier, is used as an extended example.

The MNIST benchmark consists of 60,000 handwritten Arabic numerals between 0 and 9. Each of the images is 28×28 with grayscale levels from 0 to 255 (8 bits of grayscale).

Using conventional machine learning methods as a guide, a hierarchical classification system is illustrated in FIG. 26. The input to the first layer of the classifier are 5×5 receptive fields (RFs), each of which is a subimage of the full 28×28 image. Each RF is translated to unordered form using the method described above. This results in a volley containing 50 elements being applied to layer 1.

In this example, the 5×5 RFs overlap, so that the original 28×28 image contains a total of 8×8 RFs. Each of the RFs is processed by a trained classifier consisting of 10 neurons. At layer 2, overlapping regions from layer 1 are processed. For example a 2×2 set of RF classifier outputs, represented as four 10 line bundles, are merged to form a single 40 line volley. This volley forms the input to a layer 2 classifier. This process of 2×2 reduction proceeds until a single classifier remains. The output of this classifier is the final output, with 10 lines, where the first line to spike indicates the class to which the input pattern belongs.

In a typical classifier as illustrated in FIG. 26, all the classifier neurons have the same completely connected structure. It is the supervised training with selected outputs that causes the neurons to be specialized for the classes. An alternative approach is to use variable structures and/or parameters for the classifier neurons. For example, rather than use a complete interconnect structure, one might use an irregular, perhaps randomly selected interconnection structure for classifiers. Then, one can train a large number of alternative classifiers, each with a different interconnection pattern. Using an example evaluation set, the performance (classification accuracy) of each of the alternative classifiers may then be computed. After this is done, a selected subset of the classifiers may be selected to provide input volleys to the next layer. For example, one my select the interconnection structures that yield the highest classifications accuracies, with the other interconnection structures being discarded. In effect, training in this manner results in a plastic (trainable) interconnection structure. It is not just the synaptic weights that are plastic during the training process.

Similar approaches my introduce random variations into the delay distributions, Wₘₐₓ (a different Wₘₐₓ per neuron), or the sublinear summation function, p, to name a few examples. Consequently, these other system features are effectively subject to training.

The structures and methods as described herein can be implemented in a number of ways: directly in special purpose hardware, in programmable hardware as an FPGA, or via software on a general purpose computer or graphics processor. A general block diagram for one such implementation is illustrated in FIG. 27. As shown in FIG. 27, a general computational column consists of a series of interleaved IC units and EC units, connected with addressible buffers.

The overall architecture in FIG. 27 consists of four major functional blocks.

EC: Excitatory Columns implement the excitatory column functions In training mode, EC units take the training input volley stream as input and compute the weights in the manner described above. In evaluation mode, the weights are fixed; the evaluation spike volleys are applied and the EC unit determines the output spike volleys.

IC: Inhibitory Columns perform feedforward and/or lateral inhibition on their input volley streams to produce their output volley streams.

MG: Merge Units are very simple structures which merge multiple volleys into a single volley. This amounts to concatenating the volley vectors and re-assigning spike numbers accordingly. Spike times are then adjusted according to the first spike time in the merged volley.

VA: Volley Analyzers analyze volley streams and generate statistics and plots of the observed behavior (illustrated at the bottom of FIG. 27). The VA units do not modify the volley streams in any way; they merely tap into a bundle and are an analysis tool for IC training and for guiding the design process.

As they are being processed, spike volleys can be represented in a number of ways. One is to use vectors directly, as is done in this document. For example, <4,-,0,-,-,1,-,8>ₜ can be transmitted on a bus or stored in memory using a binary encoding as is commonly done in conventional computer systems. The “-” can be represented by a special binary encoding, different from the numerical values. Alternatively, a volley can be represented as a series of pairs [<1,4>, <3,0>,<6,1>,<8,8>], where the first element of the pair indicates the element position in the volley, and the second indicates the numerical value. This method may be more efficient for sparse volleys.

Refer again to FIG. 27. For communication amongst the functional blocks, volleys (and volley trains) can be passed through addressable buffers, where each addressable buffer is associated with a bundle. By using buffer addresses an interconnection structure can be established. With this method, each block (either an EC Unit or IC Unit) is assigned a unique addressable buffer for its output volley train. Then, a subsequent unit can address the buffer(s) from which it should draw its input volley train. An interconnect pattern is implemented via the buffers which an MG unit addresses. By changing the addresses, the interconnect pattern is changed. The buffer can be used for streaming volleys from one unit to the next, or it can be filled and then emptied with a full volley train.

The diagram in FIG. 28 can be implemented directly in hardware with an interconnection network (or multiple interconnection networks) connecting the blocks. Or, it can be implemented in software where the address buffers are memory arrays and the interconnections occur via loads and stores to memory. In the software implementation, the memory address/data path is the interconnection network. The units would be implemented via software routines.

As shown in FIG. 28, each of the units is assigned a unique addressable buffer for its output volleys. The MG units may take multiple output volleys (on multiple bundles) and merge them into a single, larger output volley on a single bundle. In some implementations, an MG unit may be directly connected to an IC unit without then need for an addressable buffer in between. In some implementations, an IC unit and an EC unit may be combined into a single unit.

Training is performed for each EC unit. Each EC contains a weight array addressed by input/output pairs, where each element of the array is assigned a weight via training. Training is accomplished in the EC units, and consists of the following steps for each layer to be trained.

1) A volley is retrieved from an addressable buffer.

2) The training method described above is implemented, depending on whether the compound connection spiking neuron model is implemented, or the higher level model where the multiple paths are combined.

3) Final weights are computed and stored in the weight array.

One way for implementing training across multiple layers is to first train layer 1. After training layer 1, the training set is applied to layer 1 a second time and the output volley train is captured in an addressable buffer. This addressable buffer holds the input training set for the next layer. This process is repeated from one layer to the next. At each step, all the ECs in a layer is trained, then the evaluation set is applied to produce the training set for the ECs in the next layer.

After an EC has been trained, volley trains may be evaluated. This is accomplished via the following steps.

1) The network weights are used to generate the response functions. These may be stored in table form. Alternatively, the response functions are evaluated as needed in step 3).

2) An input volley is retrieved from an addressable buffer.

3) Training is performed. If the neurons are implemented with all the simple synapses included, then STDP training is applied. If the higher level abstract neuron model is implemented, then the averaging process is applied.

4) The output volley is formed by combining the output times (values) of the neurons making up the EC, and the volley is stored in an addressable buffer.

The MG units function with the following steps.

1) Volleys from multiple addressable buffers are retrieved.

2) The volleys are merged into a single output volley. Merging is performed by assigning a single set of spike numbers and assigning the spike times from one input bundle at a time to the single output bundle.

3) The final output volleys are written into the output addressable buffer.

FIG. 29 illustrates the functions performed in an EC, consisting of multiple neurons (only two are shown in the figure, but any number could be used. In the preferred implementation, volleys held in the addressable buffers are based on a global timing frame of reference. The following method is used.

1) A volley is read from an addressable buffer.

2) The spike with the minimum time is determined; this is tₘᵢₙᵢ for neuron i. Then tₘᵢₙᵢ is subtracted from each of the spike times in the bundle in order to normalize it.

3) Output spike times are determined by the neuron models as described in earlier, depending on whether the neurons are implemented with the compound connection spiking neuron model, or the higher level abstract neuron model where the compound connections are combined.

4) The output spike volleys are then adjusted back to a global frame of reference by adding back in tₘᵢₙᵢ. This assures that the spike times in all the output bundles are in the same global frame of reference; in other words, they reflect actual time relationships.

An advantage of this approach is that the global time reference is maintained solely through local operations.

If one uses the global time reference t=0 at the first layer, as spike volleys pass through multiple succeeding layers, the actual times with respect to t=0 will gradually increase, potentially without bound. This growth may be undesirable because of the storage and computation resources it may needlessly consume. As an alternative, the global time reference can be adjusted occasionally by subtracting an optional adjustment to from all global spike times, as shown in FIG. 29. This adjustment value can be determined during training by computing the average minimum actual spike time for all the spikes in a layer. It is possible that such an adjustment will lead to a negative relative spike time. However, this poses no problem. In this case the normalization time t_{N} will be a negative value, which, when subtracted will bring the normalized volley back to 0 or above.

If this procedure is followed as volleys move through the system, then at any layer all the volleys feeding individual ECs will have encodings that are temporally consistent.

Example: Consider a simple system, where the complete input volley is <3, 6, 4, 5, 7, 2, 6, 3, 8, 2, 3, 1, 4, 1, 3, 5>ₜ. Say the first half of the spikes are processed by Neuron₁ and the second half will be processed by Neuron₂. Then, the unnormalized input volley going to Neuron₁ is <3, 6, 4, 5, 7, 2, 6, 3>ₜ, and the unnormalized input volley going to Neuron₂ is <8, 2, 3, 1, 4, 1, 3, 5>ₜ. Prior to processing, both volleys are normalized, using tₘᵢₙ₁=2, and tₘᵢₙ₂=1, this yields normalized input volleys <1, 4, 2, 3, 5, 0, 4, 2>ₜ and <7, 1, 2, 0, 3, 0, 2, 4>ₜ. These input volleys are processed, and for the sake of example, say the two output volleys are <2,1,4,5>ₜ and <3,6,8,1>ₜ for Neuron₁ and Neuron₂, respectively. These are then adjusted by adding back in the t_{N} values. This yields the outputs <4,3,6,7>ₜ and <4,7,9,2>ₜ. When combined the unnormalized volley <4,3,6,7, 4,7,9,2>ₜ is passed to the next level. By doing this, the neurons in a CC operate within their own temporal frames of reference, yet the final combined spike volley reflects correct actual time relationships among all the spikes between layers. Note that in an unnormalized volley, the spikes may exceed Tₘₐₓ. □

1. A spiking neural network comprising: multiple interconnected excitatory neurons, each having multiple inputs and an output; information is encoded via spike timing relationships encoded as volleys of spikes on bundles, each bundle consisting of one or more lines; the output of one neuron is connected to the inputs of multiple other neurons; the output of one neuron may have one or more connections to a single other neuron; each of the connections has an associated synaptic weight and delay; synaptic weights are trained via the application of training patterns encoded as spike volleys; an output spike from a pre-synaptic neuron results in a spike response at the connected post-synaptic neuron; the spike response can be expressed as a unimodal function of time, which depends on the synaptic delay and the synaptic weight; the post-synaptic excitatory neuron sums the unimodal functions and produces an output spike at the first time a threshold level is achieved by the sum of the response functions; if the threshold value is not reached, then there is no output spike.

2. The network of claim 1 wherein values are encoded as spike volleys, in which the spike that occurs earliest in time is assigned a parameterized maximum value; spikes occurring later in time have their values determined on a relative basis with respect to the time of the first spike.

3. The network of claim 2 wherein: the unimodal spike response functions are piecewise linear, with a parameterized rise time and a parameterized fall time.

4. The network of claim 3 wherein excitatory neurons are combined to form excitatory columns, each column consisting of one or more excitatory neurons. The neurons in a column operate concurrently on input information encoded as spike volleys, communicated via bundles of lines; the output of an excitatory column is also encoded as a spike volley consisting of the combined spike outputs of all the neurons in the column.

5. The network of claim 4 further comprising: a bulk model for inhibition wherein a parameterized model of feedforward inhibition is implemented.

6. The network of claim 4 further comprising: a bulk model for inhibition wherein a parameterized model of lateral inhibition is implemented.

7. A network of claim 4 wherein multiple connections between a pre-synaptic neuron and a single post-synaptic neuron are modeled individually, each connection having its own delay and weight; the weights are established via a training process that applies a training set of input patterns and adjusts the weights according to an STDP update method.

8. The network of claim 4 wherein multiple connections between a pre-synaptic neuron and a single post-synaptic neuron are modeled as a single compound synaptic connection; each such compound connection has an associated weight that defines a unimodal response function for that compound connection; the weights are established via a training process that averages the input values for members of a training set.

9. The network of claim 7 being applied to the classification problem, wherein training is supervised.

10. The network of claim 7 being applied to the classification problem, wherein training is unsupervised.

11. The network of claim 8 being applied to the classification problem, wherein training is supervised.

12. The network of claim 8 being applied to the classification problem, wherein training is unsupervised.

13. A spiking neural network architecture consisting of multiple layers of excitatory neurons, arranged as excitatory columns, interconnected with bulk inhibition modeled as inhibitory columns; information is passed via bundles consisting of lines which carry information in the form of volleys consisting of spikes.

14. The network of claim 13 wherein all of the network connections are feedforward and excitatory and inhibitory columns appear in an interleaved fashion.

15. The network of claim 13 wherein global actual time is maintained throughout the network model, with conversion to local actual time for neuron computations, followed by re-conversion to global actual time for inter-column communication.
